(19) United States
(12) Patent Application Publication
(10) Pub. No.: US 2012/0001813 A1
(43) Pub. Date: Jan. 5, 2012

(54) USB Antenna with a Bottle Opener

(75) Inventor: Yung-Chang Lin, Taipei County (TW)

(73) Assignee: GEMTEK TECHNOLOGY CO., LTD., Hsinchu County (TW)

(21) Appl. No.: 12/883,403

(22) Filed: Sep. 16, 2010

(30) Foreign Application Priority Data
Jul. 5, 2010 (TW) 099122078

(51) Int. Cl. H01Q 1/00; B67B 7/44

(52) U.S. Cl. 343/720; 81/3.09

(57) ABSTRACT

The present invention discloses an USB antenna device with a bottle opener, which comprises a main body being a casing; a connector being mounted on an end of the main body; a bottle opener being concavely disposed on a side of the main body; and a wireless antenna for transmitting and receiving wireless signals or microwaves. In the present invention, the available limited space in the USB antenna device can be used efficiently because the wireless antenna occupying a certain area in the traditional USB antenna device is disposed corresponding to a bottle opener structure. That is, the USB antenna device of the present invention not only is easy to carry, but can also provide a function of opening the bottle.

### BACKGROUND OF THE INVENTION

1. Field of the Invention

The present invention relates to a USB antenna device, and more particularly to a USB antenna device with a bottle opener.

2. Description of Related Art

With the ever-changing electronic technology, the use of an antenna in a computer, a notebook computer or an intelligent electronic device as a wireless network transmission medium has become a well-known and widely used technical means. In order to enable wireless network transmission on a computer, a notebook computer or an intelligent electronic device originally provided without an antenna, an external wireless antennas of a universal serial bus (USB) interface, i.e. an USB antenna, has been developed and popularly used.

However, generally in such a wireless antenna, a sheet type antenna must be provided as a signal transmission conductor. The sheet type antenna occupies a certain area, which is difficult to be reduced. In terms of functionality, it is unfortunate that the wireless antenna doesn't have other practical functions except transmitting signals. Therefore, based on the aforementioned shortcomings, the inventors have speculated and designed a USB antenna device with a bottle opener, which could solve the drawbacks of the existing techniques so as to improve the industrial applicability thereof.

### SUMMARY OF THE INVENTION

In view of the above-mentioned problems of the prior art, the primary objective of the present invention is to provide a USB antenna device with a bottle opener, which could overcome the difficulties of the existing techniques.

To achieve the foregoing objectives, the technical measures adopted by the invention include a USB antenna device with a bottle opener, which comprises a main body being a casing having space inside, and a wireless transceiver circuit module being mounted inside the casing; a connector being an USB metal terminal, and extending from and being disposed on an end of the main body; a bottle opener being concavely disposed on a side of the main body; and a wireless antenna being electrically connected to the wireless transceiver module as a transmitting and receiving means of wireless signals or microwaves.

Preferably, the bottle opener is made of the wireless antenna.

Preferably, the wireless antenna is mounted inside the bottle opener.

Preferably, the wireless antenna is mounted on along a surface of the bottle opener.

The bottle opener comprises a fulcrum element and a lift element formed on the main body. The lift element is positioned closer to the end where the connector is disposed than the fulcrum element, or the fulcrum element is positioned closer to the end where the connector is disposed than the lift element. A cutout is formed between the fulcrum element and the lift element.

In accordance with the present invention, the available limited space in the USB antenna device can be used efficiently because the wireless antenna occupying a certain area in the traditional USB antenna device may be disposed corresponding to a bottle opener structure. Therefore, the USB antenna device of the present invention not only is easy to carry, but can also provide a function of opening the bottle at the same time.

### BRIEF DESCRIPTION OF THE DRAWINGS

FIG. 1 is a schematic view of a USB antenna device with a bottle opener according to an embodiment of the present invention.

FIG. 2 is a first operating view of the USB antenna with a bottle opener of FIG. 1.

FIG. 3 is a second operating view of the USB antenna with a bottle opener of FIG. 1.

### DETAILED DESCRIPTION OF THE PREFERRED EMBODIMENTS

The characteristics, contents, advantages and achieved effects of the present invention will become more fully understood from the detailed description given herein below and the accompanying drawings which are given by way of illustration only, and thus are not limitative of the present invention.

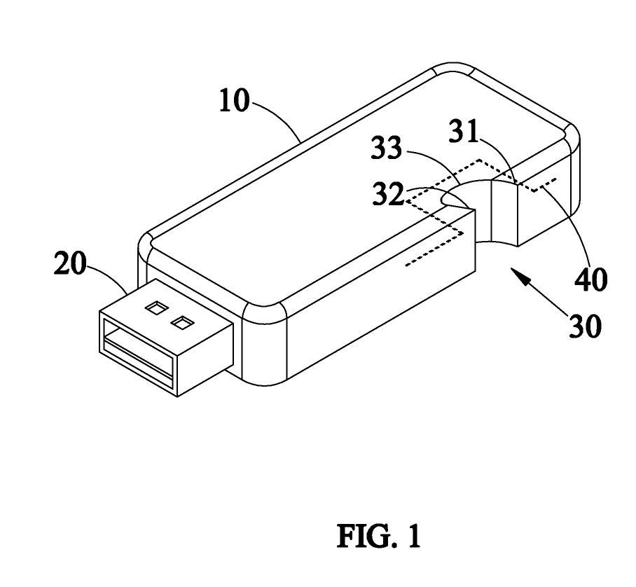

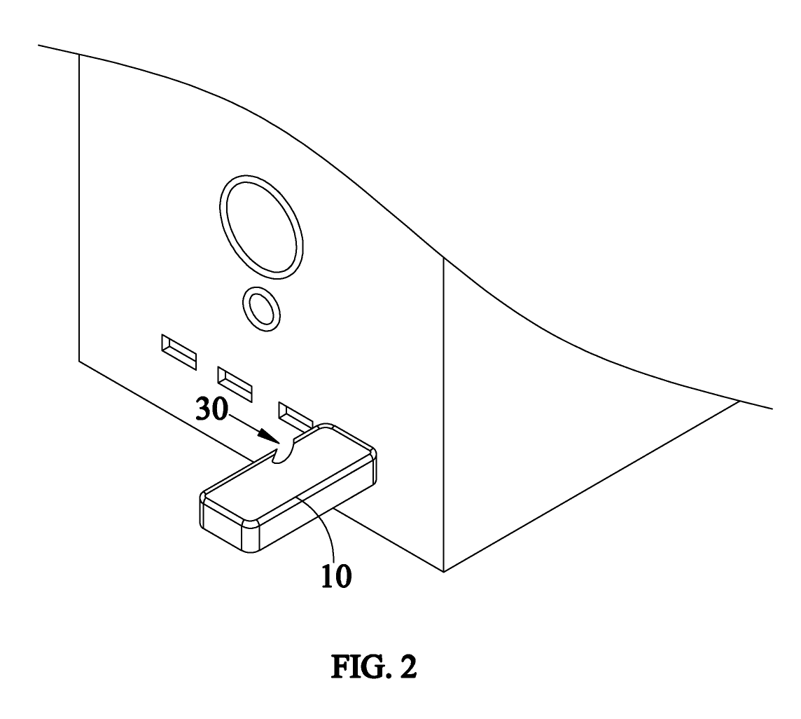

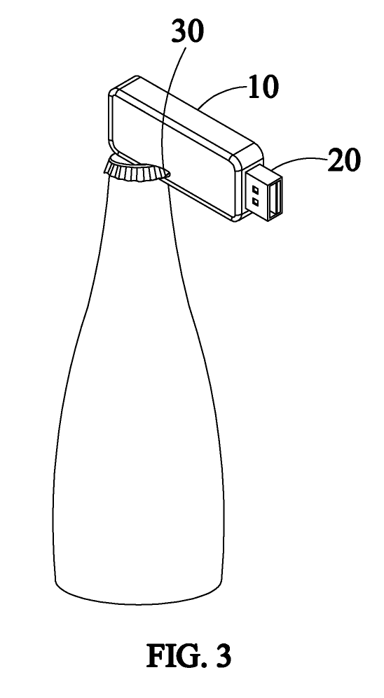

Referring to FIGS. 1 to 3, a USB antenna device with a bottle opener according to an embodiment of the present invention may comprise a main body (10), a connector (20), a bottle opener (30) and a wireless antenna (40).

The main body (10) is a casing having space inside, which may be in a longitudinal shape. A wireless transceiver module may be mounted inside the casing.

The connector (20) may be an USB metal terminal, which may extend from and be mounted on an end of the main body (10).

The bottle opener (30) is concavely disposed on a side of the main body (10), which may further comprise a fulcrum element (31) and a lift element (32) formed on the main body (10). The lift element (32) may be positioned closer to the end where the connector is disposed than the fulcrum element (31), or the fulcrum element (31) may be positioned closer to the end where the connector is disposed than the lift element (32). A cutout (33) is formed between the fulcrum element (31) and the lift element (32). The opening of the cutout (33) can engage the top of a bottle cap. The fulcrum element (31) can be used to fit against the top of the bottle cap and act as a fulcrum. The lift element (32) can be used to pass beneath the rim of the bottle cap and be pushed upward to pry the bottle cap away from the bottle.

The wireless antenna (40) may be mounted inside the bottle opener (30), as shown in FIG. 1. Optionally, the bottle opener (30) may be made of the wireless antenna (40), or the wireless antenna (40) may be mounted on along a surface of the bottle opener (30) (not shown). The fulcrum element (31) and the lift element (32) are extending free ends in structure, such that they can be electrically connected to the wireless transceiver module inside the main body (10) as a transmitting and receiving means of wireless signals or microwaves. The wireless antenna (40) may be a Wi-Fi wireless network antenna, a WiMax (Worldwide Interoperability for Microwave Access) antenna or a bluetooth transmission (BT) antenna.

The present invention combines the bottle opener on the main body of the USB antenna device corresponding to the wireless antenna, thereby efficiently using space of the USB antenna device. The USB antenna device with a bottle opener according to the present invention serves as an easy-to-carry, exposed antenna as well as provides a function of opening the bottle. It is advantageous to practical use.

The embodiments described above are only intended to illustrate the technical concepts and features of the present invention for those skilled in the art to understand the technical content of the present invention and to implement the present invention and are not intended to limit the scope thereof. Various changes or modifications can be made without departing from the spirit and scope of the invention. All such equivalent changes and modifications shall be included within the scope of the appended claims.

In summarization of the foregoing description, the present invention breaks through the prior art concept and indeed can achieve the effects to be improved, and it is also not easy for those skilled in the art to infer. Furthermore, the present invention is not known to the public prior to filing a patent application and meets the requirements of inventiveness and practical applicability of patents. Therefore, the application for a patent is duly filed accordingly.

What is claimed is:

1. A USB antenna device with a bottle opener, comprising:
a main body being a casing having space inside, a wireless transceiver module being mounted inside the casing;
a connector being an USB metal terminal, extending from and being disposed on an end of the main body;
a bottle opener being concavely disposed on a side of the main body; and
a wireless antenna being electrically connected to the wireless transceiver module as a transmitting and receiving means of wireless signals or microwaves.

2. The USB antenna device with a bottle opener of claim 1, wherein the bottle opener is made of the wireless antenna.

3. The USB antenna device with a bottle opener of claim 1, wherein the wireless antenna is mounted inside the bottle opener.

4. The USB antenna device with a bottle opener of claim 1, wherein the wireless antenna is mounted on along a surface of the bottle opener.

5. The USB antenna device with a bottle opener of claim 1, wherein the bottle opener comprises a fulcrum element and a lift element formed on the main body, the lift element is positioned closer to the end where the connector is disposed than the fulcrum element, and a cutout is formed between the fulcrum element and the lift element.

6. The USB antenna device with a bottle opener of claim 1, wherein the bottle opener comprises a fulcrum element and a lift element formed on the main body, the fulcrum element is positioned closer to the end where the connector is disposed than the lift element, and a cutout is formed between the fulcrum element and the lift element.

7. The USB antenna device with a bottle opener of claim 1, wherein a shape of the main body comprises longitudinal.

8. The USB antenna device with a bottle opener of claim 1, wherein the wireless antenna comprises a Wi-Fi wireless network antenna.

9. The USB antenna device with a bottle opener of claim 1, wherein the wireless antenna comprises a WiMax (Worldwide Interoperability for Microwave Access) antenna.

10. The USB antenna device with a bottle opener of claim 1, wherein the wireless antenna comprises a bluetooth transmission antenna.
